(19) United States
(12) Patent Application Publication
(10) Pub. No.: US 2018/0345927 A1
(43) Pub. Date: Dec. 6, 2018

(54) BRAKE HYDRAULIC PRESSURE UNIT

(71) Applicant: Robert Bosch GmbH, Stuttgart (DE)

(72) Inventor: Kosaku Sagayama, Kanagawa (JP)

(21) Appl. No.: 16/100,332

(22) Filed: Aug. 10, 2018

Related U.S. Application Data
(62) Division of application No. 15/326,597, filed on Jan. 16, 2017.

(30) Foreign Application Priority Data
Jul. 15, 2014 (JP) 2014-144689

(51) Int. Cl. B60T 8/36; B62L 3/02; B60T 8/34

(52) U.S. Cl. CPC B60T 8/368; B62L 3/023; B60T 8/344; B60T 8/34; B60T 8/341; B60T 8/363

(57) ABSTRACT

A pumpless-type brake hydraulic pressure unit comprising a housing that includes a base body, an inlet valve hole accommodating an inlet valve, an outlet valve hole accommodating an outlet valve, a master cylinder port connected to a master cylinder, a reservoir port connected to a reservoir, a wheel cylinder port connected to a wheel cylinder, and a pipeline. The base body includes a first side face, a second side face, and a third side face. The inlet valve hole and the outlet valve hole are open on the first side face, the master cylinder port and the wheel cylinder port are provided on the second side face. The first side face and the second side face are perpendicular to one another, the first side face and the third side face are perpendicular to one another, and the second side face and the third side face are perpendicular to one another.

### RELATED APPLICATIONS

This application is a divisional of U.S. patent application Ser. No. 15/326,597, filed on Jan. 16, 2017, which is a 371 of PCT Application PCT/JP2015/068017, filed on Jun. 23, 2015, which claims foreign priority to Japanese Application 2014-144689, filed on Jul. 15, 2014. The disclosures of all three of the foregoing are incorporated by reference herein in their entireties.

### BACKGROUND OF THE INVENTION

The present invention relates to a brake hydraulic pressure unit, and particularly relates to a brake hydraulic pressure unit used in a brake system including an anti-lock brake system.

In the related art, there is a known automatic two-wheel vehicle equipped with the brake system including the anti-lock brake system (hereinafter, referred to as the ABS). For example, as the brake system in the related art, the ABS including a one channel-type pumpless brake hydraulic pressure unit has been used.

For example, the brake hydraulic pressure unit in the related art includes a metal base body in which a hydraulic pipeline is formed to be provided between a master cylinder and a wheel cylinder port which is connected to a wheel cylinder provided in a brake of a wheel. The base body accommodates the master cylinder, an inlet valve, an outlet valve, and a reservoir. In the base body, the master cylinder, the inlet valve, the outlet valve, the reservoir, and the wheel cylinder are connected to one another through the hydraulic pipeline which is capable of ABS controlling and has a complicated shape of a pipeline.

In the base body of the brake hydraulic pressure unit in the related art, due to the complicated shape of the hydraulic pipeline, and in order to avoid interference from members accommodated in the base body, there is a need to provide a gap for a portion adjacent to the hydraulic pipeline. Thus, the base body becomes massive in size. Moreover, on account of the shape of the hydraulic pipeline, the brake hydraulic pressure unit is restricted in a mounting position on an automatic two-wheel vehicle, resulting in poor mounting characteristics.

Therefore, hitherto, a brake hydraulic pressure unit has been proposed aiming to improve the mounting characteristics with respect to an automatic two-wheel vehicle (for example, refer to JP-A-2009-234502).

### SUMMARY OF THE INVENTION

However, a brake hydraulic pressure unit in the related art is still massive in size and is still restricted in a mounting position on an automatic two-wheel vehicle, resulting in poor mounting characteristics. Moreover, due to a complicated hydraulic pipeline, it is troublesome to perform processing of the hydraulic pipeline.

In order to solve the above-described problems, the present invention aims to provide a brake hydraulic pressure unit in which mounting characteristics with respect to a vehicle can be improved.

In order to achieve the aforementioned object, the present invention provides a brake hydraulic pressure unit used in a brake system including an anti-lock brake system. The brake hydraulic pressure unit includes an inlet valve, an outlet valve, and a housing. The housing includes a base body, an inlet valve hole accommodating the inlet valve, an outlet valve hole accommodating the outlet valve, a master cylinder port connected to a master cylinder, a reservoir port connected to a reservoir, a wheel cylinder port connected to a wheel cylinder, and a pipeline. The base body includes a first side face, a second side face, and a third side face. The inlet valve hole and the outlet valve hole are open on the first side face, the master cylinder port and the wheel cylinder port are provided on the second side face, and the reservoir port is provided on the third side face. The first side face, the second side face, and the third side face are perpendicular to one another.

In the brake hydraulic pressure unit according to the present invention, an opening of the inlet valve hole and an opening of the outlet valve hole on the first side face respectively have gaps different from each other with respect to the second side face.

In the brake hydraulic pressure unit according to the present invention, the master cylinder port and the wheel cylinder port on the second side face respectively have gaps different from each other with respect to the first side face.

The brake hydraulic pressure unit according to the present invention includes a valve case that accommodates the inlet valve and the outlet valve.

The brake hydraulic pressure unit according to the present invention includes a control substrate that controls the inlet valve and the outlet valve. The control substrate is installed in the valve case.

The brake hydraulic pressure unit according to the present invention includes a control substrate that controls the inlet valve and the outlet valve. The control substrate is installed away from the brake hydraulic pressure unit.

In the brake hydraulic pressure unit according to the present invention, the base body is a rectangular parallelepiped.

In the brake hydraulic pressure unit according to the present invention, the brake system is a one channel-type system.

In the brake hydraulic pressure unit according to the present invention, the anti-lock brake system is a pumpless-type system.

In the brake hydraulic pressure unit according to the present invention, the master cylinder is a body separated from the brake hydraulic pressure unit.

In order to achieve the aforementioned object, in a brake hydraulic pressure unit according to the present invention, a first side face on which an inlet valve hole and an outlet valve hole are open, a second side face on which a master cylinder port and a wheel cylinder port are provided, and a third side face on which a reservoir port is provided are perpendicular to one another. Therefore, a base body can be miniaturized. Moreover, in the brake hydraulic pressure unit according to the present invention, since the base body is miniaturized, a space necessary for mounting the base body can be minimized and choice for mounting positions of the base body in a vehicle can be widely ranged. Thus, it is possible to improve mounting characteristics of the brake hydraulic pressure unit in a vehicle.

According to the brake hydraulic pressure unit of the present invention, an opening of the inlet valve hole and an opening of the outlet valve hole on the first side face respectively have gaps different from each other with respect to the second side face. Therefore, a shape of a pipeline can be simplified. Thus, it is possible to further miniaturize the base body. Moreover, it is possible to process the pipeline easily.

According to the brake hydraulic pressure unit of the present invention, the master cylinder port and the wheel cylinder port on the second side face respectively have gaps different from each other with respect to the first side face. Therefore, the shape of the pipeline can be further simplified. Thus, it is possible to further miniaturize the base body. Moreover, it is possible to process the pipeline more easily.

In the brake hydraulic pressure unit according to the present invention, a valve case that protects the inlet valve and the outlet valve is included. Therefore, the inlet valve and the outlet valve can be protected from the outside, and the inlet valve and the outlet valve can be prevented from being damaged due to shock. Accordingly, even though a position in a vehicle is likely to be subjected to shock, the position can be set as the mounting position of the brake hydraulic pressure unit. Thus, it is possible to further improve mounting characteristics of the brake hydraulic pressure unit in a vehicle.

In the brake hydraulic pressure unit according to the present invention, a control substrate controlling the inlet valve and the outlet valve is installed in a valve holding body. Thus, it is possible to further miniaturize the brake hydraulic pressure unit.

According to the brake hydraulic pressure unit of the present invention, the control substrate controlling the inlet valve and the outlet valve is installed away from the brake hydraulic pressure unit. Therefore, mounting forms of the brake hydraulic pressure unit can vary. Thus, it is possible to further improve mounting characteristics of the brake hydraulic pressure unit in a vehicle.

According to the brake hydraulic pressure unit of the present invention, the base body is a rectangular parallelepiped. Thus, it is possible to further improve mounting characteristics of the brake hydraulic pressure unit in a vehicle.

According to the brake hydraulic pressure unit of the present invention, the brake system is a one channel-type system. Therefore, the pipeline can be further simplified. Thus, it is possible to further miniaturize the base body.

According to the brake hydraulic pressure unit of the present invention, an ABS is a pumpless-type system. Therefore, the pipeline can be further simplified. Thus, it is possible to further miniaturize the base body.

According to the brake hydraulic pressure unit of the present invention, the master cylinder is a body separated from the brake hydraulic pressure unit. Therefore, the base body can be further miniaturized and mounting forms of the brake hydraulic pressure unit can vary further. Thus, it is possible to further improve mounting characteristics of the brake hydraulic pressure unit in a vehicle.

### BRIEF DESCRIPTION OF THE DRAWINGS

FIG. 1 is a perspective view illustrating a brake hydraulic pressure unit of a first embodiment of the present invention.

FIG. 2 is an exploded perspective view of the brake hydraulic pressure unit in FIG. 1.

FIG. 3 is a diagram of a hydraulic circuit illustrating a schematic configuration of a hydraulic pipeline formed in a base body illustrated in FIG. 2.

FIGS. 4(a), 4(b) and 4(c) are transparent views illustrating a pipeline structure of the hydraulic pipeline inside the base body illustrated in FIG. 2. FIG. 4(a) is a perspective view illustrating the pipeline structure, FIG. 4(b) is a diagram illustrating the pipeline structure when the base body is seen in a direction horizontal to a second side face, and FIG. 4(c) is a diagram illustrating the pipeline structure when the base body is seen in a direction horizontal to a first side face.

FIGS. 5(a), 5(b) and 5(c) are transparent views illustrating another pipeline structure of the hydraulic pipeline inside the base body of a second embodiment of the present invention. FIG. 5(a) is a perspective view illustrating the pipeline structure, FIG. 5(b) is a diagram illustrating the pipeline structure when the base body is seen in the direction horizontal to the second side face, and FIG. 5(c) is a diagram illustrating the pipeline structure when the base body is seen in the direction horizontal to the first side face.

### DETAILED DESCRIPTION

Hereinafter, embodiments of the present invention will be described in detail with reference to the drawings.

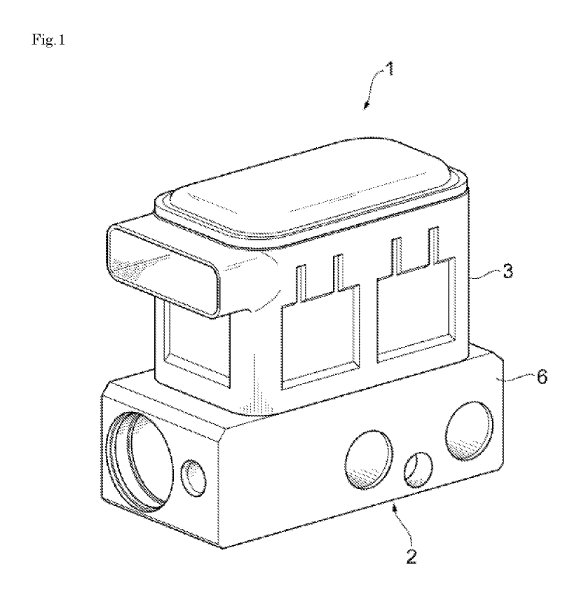

FIG. 1 is a perspective view illustrating a brake hydraulic pressure unit of a first embodiment of the present invention. As illustrated in FIG. 1, a brake hydraulic pressure unit 1 according to the first embodiment of the present invention includes a housing 2 and a valve case 3 which protects valves described below. The brake hydraulic pressure unit 1 is used in a brake system including an ABS of a vehicle, for example, a motorcycle. The brake system may be a front wheel system or a rear wheel system of a motorcycle. The motorcycle is not limited to a vehicle including one front wheel and one rear wheel. The motorcycle may be a vehicle including one front wheel and two rear wheels and may be a vehicle including two front wheels and one rear wheel. In the present embodiment, the brake hydraulic pressure unit 1 is used in the front wheel brake system of a motorcycle.

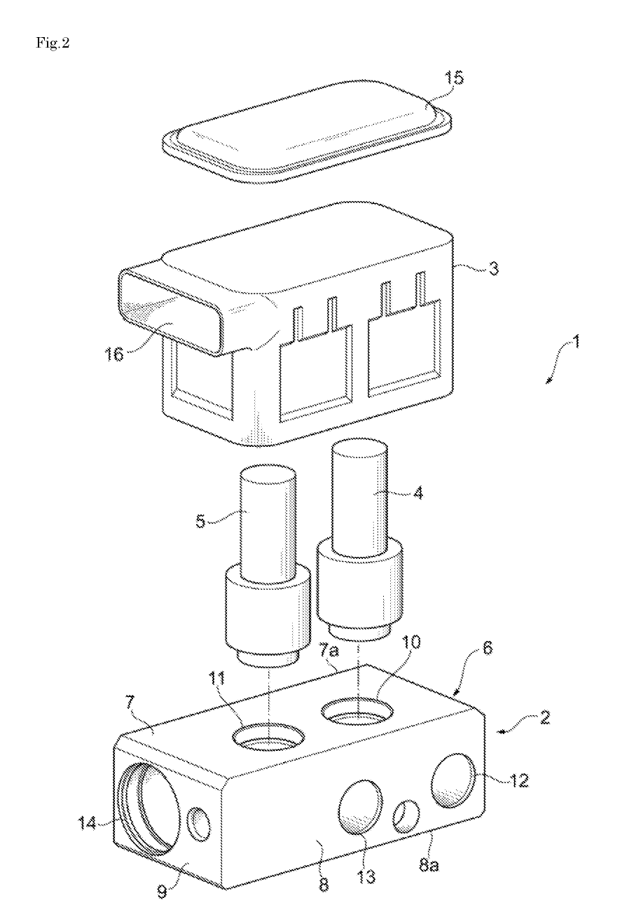

FIG. 2 is an exploded perspective view of the brake hydraulic pressure unit 1. As illustrated in FIG. 2, the brake hydraulic pressure unit 1 includes an inlet valve 4 which is held in the housing 2 and is accommodated in the valve case 3. The brake hydraulic pressure unit 1 includes an outlet valve 5 which is held in the housing 2 and is accommodated in the valve case 3 in the same manner. The inlet valve 4 and the outlet valve 5 form a two-port electromagnetic valve. The housing 2 includes a base body 6.

The base body 6 is a metallic member made of metal such as an aluminum alloy, including three side faces such as a first side face 7, a second side face 8, and a third side face 9. In the base body 6, the first side face 7, the second side face 8, and the third side face 9 are orthogonal to one another. In the present embodiment, the base body 6 has a rectangular parallelepiped shape. The base body 6 includes an inlet valve hole 10 accommodating the inlet valve 4, an outlet valve hole 11 accommodating the outlet valve 5, a master cylinder port 12 to be connected to a master cylinder, a wheel cylinder port 13 to be connected to a wheel cylinder of a front wheel brake described below, and a reservoir port 14 to be connected to a reservoir described below. The inlet valve hole 10 and the outlet valve hole 11 are open on the first side face 7. The master cylinder port 12 and the wheel cylinder port 13 are provided on the second side face 8. The reservoir port 14 is provided on the third side face 9. Inside the base body 6, a hydraulic pipeline 20 is formed as a pipeline described below. The inlet valve hole 10, the outlet valve hole 11, the master cylinder port 12, the wheel cylinder port 13, and the reservoir port 14 are formed by cutting the base body 6.

As illustrated in FIG. 2, on the first side face 7, the inlet valve hole 10 and the outlet valve hole 11 are aligned in a direction of a long side 7a of the first side face 7, and the outlet valve hole 11 is provided on the third side face 9 side. On the second side face 8, the master cylinder port 12 and the wheel cylinder port 13 are aligned in a direction of a long side 8a of the second side face 8, and the wheel cylinder port 13 is provided on the side of the third side face 9.

The valve case 3 is made of a resin, for example, and has a control substrate 15 which is installed on a side opposite to the housing 2. A power source (not illustrated), for example, a power source connector 16 which is connected to a battery is formed in the valve case 3.

The control substrate 15 is connected to the power source connector 16. Electricity is supplied from the power source via the power source connector 16, thereby controlling operations of the brake hydraulic pressure unit 1. More specifically, the control substrate 15 controls the inlet valve hole 10 and the outlet valve hole 11 while performing braking control described below.

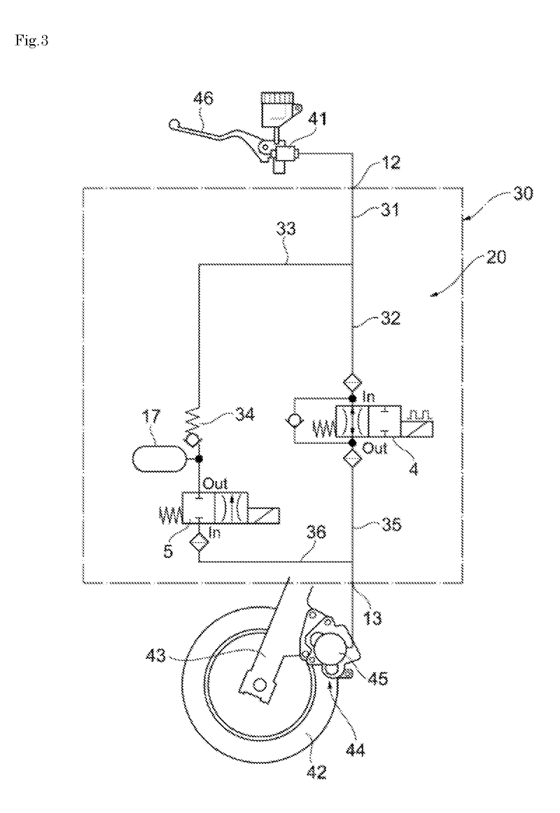

FIG. 3 is a diagram of a hydraulic circuit illustrating a schematic configuration of the hydraulic pipeline 20 formed in the base body 6.

As illustrated in FIG. 3, a hydraulic circuit 30 connects a master cylinder 41 and a wheel cylinder 45 of the front wheel brake 44 installed in a front fork 43 which rotatably holds a front wheel 42 of a motorcycle so as to allow brake fluid to flow therebetween. The hydraulic circuit 30 is provided with the inlet valve 4, the outlet valve 5, and a reservoir 17 which is connected to the reservoir port 14 of the base body 6. The hydraulic circuit 30 is filled with the brake fluid. Fluid pressure being applied to the wheel cylinder 45 is controlled through the hydraulic circuit 30 by controlling the inlet valve 4 and the outlet valve 5. Then, a front wheel brake 44 is controlled, thereby performing braking control of the front wheel.

The master cylinder 41 includes a piston portion (not illustrated) which moves in association with movements of a brake lever 46 operated by an operator. The master cylinder 41 is connected to a circuit portion 31 of the hydraulic circuit 30. In response to movements of the piston portion, pressure of the brake fluid inside the hydraulic circuit 30 increases or decreases.

The circuit portion 31 branches off to a circuit portion 32 and a circuit portion 33 on a downstream side. The circuit portion 32 is connected to the inlet valve 4 on an entrance side via a filter. The circuit portion 33 is connected to the outlet valve 5 on an exit side via a check valve 34. The reservoir 17 is connected to the circuit portion 33 between the check valve 34 and the outlet valve 5.

A circuit portion 35 is connected to the inlet valve 4 on an exit side via the filter. The circuit portion 35 is connected to the wheel cylinder 45 at an end on a side opposite to the end which is connected to the inlet valve 4. A circuit portion 36 is connected to the outlet valve 5 on an entrance side via the filter. The circuit portion 36 is connected to the circuit portion 35 at an end on a side opposite to the end which is connected to the outlet valve 5.

The majority of the portion of the hydraulic circuit 30 is formed inside the base body 6. More specifically, as illustrated in FIG. 3, the circuit portion 31 is formed inside the base body 6 from the master cylinder port 12 to a portion on the inlet valve 4 side, and the circuit portion 35 is formed inside the base body 6 from the wheel cylinder port 13 to a portion on the outlet valve 5 side. The circuit portions 32, 33, and 36 are formed inside the base body 6.

The inlet valve 4 is open at all times, thereby allowing the brake fluid to flow via a throttle in both directions which are a direction from the entrance to the exit of the inlet valve 4, and a direction from the exit to the entrance of the same. When anti-lock braking control is performed and the inlet valve 4 is energized, the inlet valve 4 is caused to be in a closed valve state by a solenoid, thereby blocking the brake fluid from flowing between the entrance and the exit of the inlet valve 4. The terms such as the entrance and exit of the inlet valve 4 are used for convenience of descriptions. The circuit portion 32 side is referred to as the entrance, and the circuit portion 35 side is referred to as the exit.

The outlet valve 5 is closed at all times, thereby blocking the brake fluid from flowing between the entrance and the exit of the outlet valve 5. When anti-lock braking control is performed and the outlet valve 5 is energized, the outlet valve 5 is caused to be in an open valve state by the solenoid. In the open valve state, the outlet valve 5 allows the brake fluid to flow via the throttle in only the direction from the entrance direction to the exit direction thereof. The terms such as the entrance and exit of the outlet valve 5 are used for convenience of descriptions. The circuit portion 36 side is referred to as the entrance, and the circuit portion 33 side is referred to as the exit.

The check valve 34 allows flowing in a direction from the reservoir 17 to the master cylinder port 12 on a downstream side, that is, in the circuit portion 33.

In the aforementioned brake system, the structures of the master cylinder 41 and the front wheel brake 44 are known structures. Therefore, descriptions thereof are omitted. The structures of the inlet valve 4 and the outlet valve 5 are not limited to the above-described structures, and thus, it is possible to apply valves having different structures.

As described above, the brake system according to the present embodiment is a one channel-type system, and the ABS does not include a pump. Anti-lock braking control executed by the ABS is known control. For example, when performing anti-lock braking control, the hydraulic circuit 30 operates as follows.

While ordinary braking control is performed by operating the brake lever 46, for example, if the control substrate 15 detects a locked state or a possibility of an occurrence of the locked state in a wheel 42 via a wheel rotation sensor (not illustrated), anti-lock braking control starts. As anti-lock braking control starts, the control substrate 15 first causes the inlet valve 4 to be in an energized state and closes the inlet valve 4. Then, the control substrate 15 blocks the brake fluid from being supplied to the wheel cylinder 45, thereby cutting off a pressure increase of the wheel cylinder 45. Meanwhile, the control substrate 15 causes the outlet valve 5 to be in an energized state and opens the outlet valve 5. Then, the control substrate 15 allows the brake fluid to flow from the wheel cylinder 45 to the reservoir 17, thereby depressurizing the wheel cylinder 45. Accordingly, the locked state of the front wheel 42 is cancelled or is avoided. The control substrate 15 may be set to perform opening and closing of the outlet valve 5 only once, or may be set to perform multiple times. When it is determined that the wheel cylinder 45 is depressurized by a predetermined amount, the control substrate 15 cuts off energization to the outlet valve 5 and closes the outlet valve 5. Then, the control substrate 15 cuts off energization to the inlet valve 4 for a short period of time, thereby increasing pressure of the wheel cylinder 45. While the ABS is in operation, pressure of the wheel cylinder 45 is repeatedly increased and decreased. However, detailed descriptions of the ABS operations will be omitted. As anti-lock braking control ends, the control substrate 15 cuts off energization to the inlet valve 4. Then, the inlet valve 4 is open, thereby performing ordinary braking control in the brake system.

As the brake lever 46 returns to its original position, the inside of the master cylinder 41 is in an atmospheric pressure state so that the brake fluid inside the wheel cylinder 45 is pushed back. In accordance with an occurrence of the atmospheric pressure state, the brake fluid inside the reservoir 17 is pushed back into the pipeline via the check valve 34.

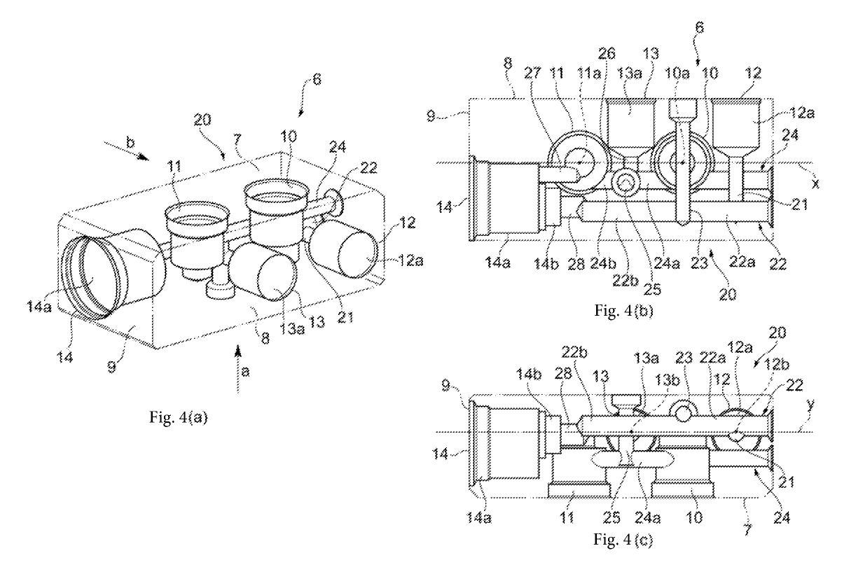

Hereinafter, with reference to FIG. 4, a pipeline structure of the hydraulic circuit 30 inside the base body 6 will be described in detail.

FIG. 4 is a transparent view illustrating a pipeline structure of the hydraulic pipeline 20 inside the base body 6. FIG. 4(a) is a perspective view illustrating the pipeline structure, FIG. 4(b) is a diagram illustrating the pipeline structure when the base body 6 is seen in a direction horizontal to the second side face 8 (arrow a direction in FIG. 4(a)), and FIG. 4(c) is a diagram illustrating the pipeline structure when the base body 6 is seen in a direction horizontal to the first side face 7 (arrow b direction in FIG. 4(a)).

As illustrated in FIGS. 4(a) to 4(c), the inlet valve hole 10 and the outlet valve hole 11 are formed so as to open on the first side face 7 of the base body 6. The inlet valve hole 10 and the outlet valve hole 11 are formed so as to be able to respectively accommodate the inlet valve 4 and the outlet valve 5 in a close contact manner, and extend perpendicularly to the first side face 7. In the present embodiment, each of the inlet valve hole 10 and the outlet valve hole 11 is a stepped hole having three different diameters. Each of the inlet valve hole 10 and the outlet valve hole 11 may extend having an angle not perpendicular to the first side face 7 within a range in which interference does not occur.

As illustrated in FIG. 4(b), the inlet valve hole 10 and the outlet valve hole 11 are aligned along an axis-x so as to position their centers 10a and 11a on the axis-x on the first side face 7 which is orthogonal to the third side face 9. As described above, the outlet valve hole 11 is positioned on the third side face 9 side.

As illustrated in FIGS. 4(a) to 4(c), a port hole 12a and a port hole 13a extending respectively from the master cylinder port 12 and the wheel cylinder port 13 formed on the second side face 8, in a direction perpendicular to the second side face 8 are formed in the base body 6. A pipeline connected to the master cylinder 41 is connected to the port hole 12a via the master cylinder port 12. The pipeline corresponds to a portion (the upstream side) of the circuit portion 31 in the hydraulic circuit 30 of FIG. 3. A pipeline connected to the wheel cylinder 45 is connected to the port hole 13a via the wheel cylinder port 13. The pipeline corresponds to a portion (the downstream side) of the circuit portion 35 in the hydraulic circuit 30 of FIG. 3. Each of the port hole 12a and the port hole 13a may extend having an angle not perpendicular to the second side face 8 within a range in which interference does not occur. In accordance with a mounting position of the brake hydraulic pressure unit 1 in a motorcycle, the master cylinder port 12 may be connected directly to the master cylinder 41, and the wheel cylinder port 13 may be connected directly to the wheel cylinder 45.

As illustrated in FIG. 4(c), the master cylinder port 12 and the wheel cylinder port 13 are aligned along an axis-y so as to position their centers 12b and 13b on the axis-y on the second side face 8 which is orthogonal to the third side face 9. As described above, the wheel cylinder port 13 is positioned on the third side face 9 side.

In the base body 6, the inlet valve hole 10, the outlet valve hole 11, the port hole 12a of the master cylinder port 12, and the port hole 13a of the wheel cylinder port 13 are formed at positions from the third side face 9 side in the order of the outlet valve hole 11, the port hole 13a of the wheel cylinder port 13, the inlet valve hole 10, and the port hole 12a of the master cylinder port 12 so as not to interfere with one another.

As illustrated in FIGS. 4(a) to 4(c), a port hole 14a extending from the reservoir port 14 formed on the third side face 9 in a direction perpendicular to the third side face 9 is formed in the base body 6. The reservoir 17 is connected to the port hole 14a via the reservoir port 14. The reservoir 17 may be formed by closing the port hole 14a, or the reservoir 17 may be embedded into the port hole 14a. The port hole 14a may extend having an angle not perpendicular to the third side face 9 within a range in which interference does not occur.

The hydraulic pipeline 20 includes pipelines 21 to 28. The pipeline 22 includes a pipeline portion 22a and a pipeline portion 22b. The pipeline 24 includes a pipeline portion 24a and a pipeline portion 24b. As illustrated in FIGS. 4(a) to 4(c), the pipeline 21 extends in a direction perpendicular to the second side face 8, and of which one end communicates with the port hole 12a connected to the master cylinder port 12. The other end of the pipeline 21 communicates with the pipeline 22. The pipeline 22 extends in a direction perpendicular to the third side face 9 and communicates with the reservoir 17 via the pipeline 28 as described below.

The pipeline 23 extends in a direction perpendicular to the second side face 8 and communicates with the pipeline 22 and a bottom portion of the inlet valve hole 10. A communication portion of the pipeline 23 and the inlet valve hole 10 is the entrance of the inlet valve 4. In the pipeline 22, the pipeline 23 is connected onto the third side face 9 side from the pipeline 21. The third side face 9 side from a portion of the pipeline 22 connected to the pipeline 23 is the pipeline portion 22b, and the opposite side is the pipeline portion 22a.

The pipeline 24 extends in a direction perpendicular to the third side face 9 and communicates with the inlet valve hole 10 and the outlet valve hole 11. The pipeline 24 communicates with the inlet valve hole 10 and the outlet valve hole 11 at a portion higher (on the opening sides of the inlet valve hole 10 and the outlet valve hole 11) than each of the bottom faces. A communication portion of the pipeline 24 and the inlet valve hole 10 is the exit of the inlet valve 4. A communication portion of the pipeline 24 and the outlet valve hole 11 is the entrance of the outlet valve 5.

The pipeline 25 extends in a direction perpendicular to the first side face 7. The pipeline 26 extends in a direction perpendicular to the second side face 8. The pipeline 25 communicates with the pipeline 24 and the pipeline 26. The pipeline 26 communicates with the pipeline 25 and the port hole 13a of the wheel cylinder port 13. In other words, the pipeline 25 and the pipeline 26 are orthogonal to each other and cause the pipeline 24 and the port hole 13a of the wheel cylinder port 13 to communicate with each other.

The pipeline 27 extends in a direction perpendicular to the third side face 9 and causes a bottom portion of the outlet valve hole 11 and the port hole 14a of the reservoir port 14 to communicate with each other. A communication portion of the pipeline 27 and the outlet valve hole 11 is the exit of the outlet valve 5.

In the pipeline 24, a portion on a side to the inlet valve hole 10 from a portion connected to the pipeline 25 is the pipeline portion 24a. A portion from a portion connected to the pipeline 25 to a portion connected to the outlet valve hole 11 is the pipeline portion 24b.

The pipeline 28 extends in a direction perpendicular to the third side face 9 from the bottom face of the port hole 14a of the reservoir port 14 and communicates with the port hole 14a of the reservoir port 14 and the pipeline 22. In more detail, a check valve accommodation chamber 14b for accommodating the check valve 34 is formed on the bottom face of the port hole 14a of the reservoir port 14. The pipeline 28 communicates with the check valve accommodation chamber 14b and the pipeline portion 22b of the pipeline 22.

As described above, the hydraulic pipeline 20 is configured to have the pipelines 21 to 28 and forms the hydraulic circuit 30 of FIG. 3. More specifically, the pipeline 21 and the pipeline portion 22a of the pipeline 22 correspond to the circuit portion 31 of the hydraulic circuit 30, and the pipeline 23 corresponds to the circuit portion 32 of the hydraulic circuit 30. The pipeline portion 24a of the pipeline 24, the pipeline 25, and the pipeline 26 correspond to the circuit portion 35 of the hydraulic circuit 30, and the pipeline portion 24b of the pipeline 24 corresponds to the circuit portion 36 of the hydraulic circuit 30. The pipeline 27, the pipeline 28, and the pipeline portion 22b of the pipeline 22 correspond to the circuit portion 33 of the hydraulic circuit 30.

In this manner, configuration elements such as the inlet valve 4, the outlet valve 5, and the reservoir 17 are accommodated in the base body 6, which is connected to the master cylinder 41 and the wheel cylinder 45, thereby forming the aforementioned hydraulic circuit 30 together with the hydraulic pipeline 20 having the above-described configuration formed inside thereof.

When the pipeline is formed by cutting the base body 6, the pipeline 22, the pipeline 24, and the pipeline 25 are open on a side face of the base body 6, as illustrated in FIG. 4. The opening portion is blocked by a plug (not illustrated). Each of the pipelines is positioned at a place other than the communicating place so as not to interfere with one another. Each of the pipelines is caused to be perpendicular to the corresponding side face. However, each of the pipelines may have an angle not perpendicular to the corresponding side face within a range in which interference does not occur.

The brake hydraulic pressure unit 1 having the above-described structure is installed below the handle bar or the seat of a motorcycle, for example.

As described above, in the brake hydraulic pressure unit 1 according to the first embodiment of the present invention, the inlet valve hole 10 and the outlet valve hole 11 are open on the first side face 7 of the base body 6. The master cylinder port 12 and the wheel cylinder port 13 are provided on the second side face 8 of the base body 6. The reservoir port 14 is provided on the third side face 9 of the base body 6. In the base body 6, the first side face 7, the second side face 8, and the third side face 9 are orthogonal and perpendicular to one another. Therefore, in the base body 6, the hydraulic pipeline 20 configuring the hydraulic circuit 30 can be formed in a small region without interference between each of the portions (the pipeline 21 to 28) of the hydraulic pipeline 20. Therefore, the base body 6 can be miniaturized, and thus, the brake hydraulic pressure unit 1 can be miniaturized. Accordingly, a space necessary for mounting the brake hydraulic pressure unit 1 can be minimized and choice for mounting positions of the brake hydraulic pressure unit 1 in a motorcycle can be widely ranged. Thus, it is possible to improve mounting characteristics of the brake hydraulic pressure unit 1 in a motorcycle.

The brake hydraulic pressure unit 1 according to the present embodiment includes the valve case 3 in which the inlet valve 4 and the outlet valve 5 are accommodated, thereby allowing the inlet valve 4 and the outlet valve 5 to be easily assembled with the base body 6. On account of the valve case 3, the inlet valve 4 and the outlet valve 5 can be protected from the outside, and the inlet valve 4 and the outlet valve 5 can be prevented from being damaged due to shock. Accordingly, even though a position in a motorcycle is likely to be subjected to shock, the position can be set as the mounting position of the brake hydraulic pressure unit 1. Thus, it is possible to further improve mounting characteristics of the brake hydraulic pressure unit 1 in a motorcycle.

In the brake hydraulic pressure unit 1 according to the present embodiment, the control substrate 15 is installed in the valve case 3. Thus, it is possible to further miniaturize the brake hydraulic pressure unit 1.

As described above, in the brake hydraulic pressure unit 1 according to the present embodiment, the control substrate 15 is installed in the valve case 3. However, the configuration of the control substrate in the present invention is not limited thereto. For example, the control substrate 15 may be installed at a position away from the brake hydraulic pressure unit 1, without being installed in the valve case 3. Therefore, mounting forms of the brake hydraulic pressure unit 1 can vary. Thus, it is possible to further improve mounting characteristics of the brake hydraulic pressure unit 1 in a motorcycle.

In the brake hydraulic pressure unit 1 according to the present embodiment, the base body 6 is a rectangular parallelepiped. Therefore, the base body 6 can be easily mounted on a motorcycle. Thus, it is possible to further improve mounting characteristics of the brake hydraulic pressure unit 1 in a motorcycle.

As described above, in the brake hydraulic pressure unit 1 according to the present embodiment, the base body 6 is shaped to be a rectangular parallelepiped. The shape of the base body 6 is not limited thereto and the base body 6 may have a different shape. However, in the base body 6 regardless of its shape, the first side face, the second side face, and the third side face are perpendicular to one another.

In the brake hydraulic pressure unit 1 according to the present embodiment, the brake system is a one channel-type system. Therefore, the hydraulic pipeline can be further simplified. Thus, it is possible to further miniaturize the base body 6.

In the brake hydraulic pressure unit 1 according to the present embodiment, the ABS is a pumpless-type system. Therefore, the hydraulic pipeline can be further simplified. Thus, it is possible to further miniaturize the base body 6.

In the brake hydraulic pressure unit 1 according to the present embodiment, the master cylinder 41 is a body separated from the brake hydraulic pressure unit 1. Therefore, the base body 6 can be further miniaturized and mounting forms of the brake hydraulic pressure unit 1 can vary further. Thus, it is possible to further improve mounting characteristics of the brake hydraulic pressure unit 1 in a motorcycle.

Subsequently, the brake hydraulic pressure unit according to a second embodiment of the present invention will be described with reference to the drawings.

In the brake hydraulic pressure unit according to the second embodiment of the present invention, only the structure of the base body is different in contrast to the brake hydraulic pressure unit 1 according to the first embodiment of the present invention. Hereinafter, only the structure of the base body in the brake hydraulic pressure unit according to the second embodiment of the present invention will be described and descriptions regarding the same configuration will be omitted.

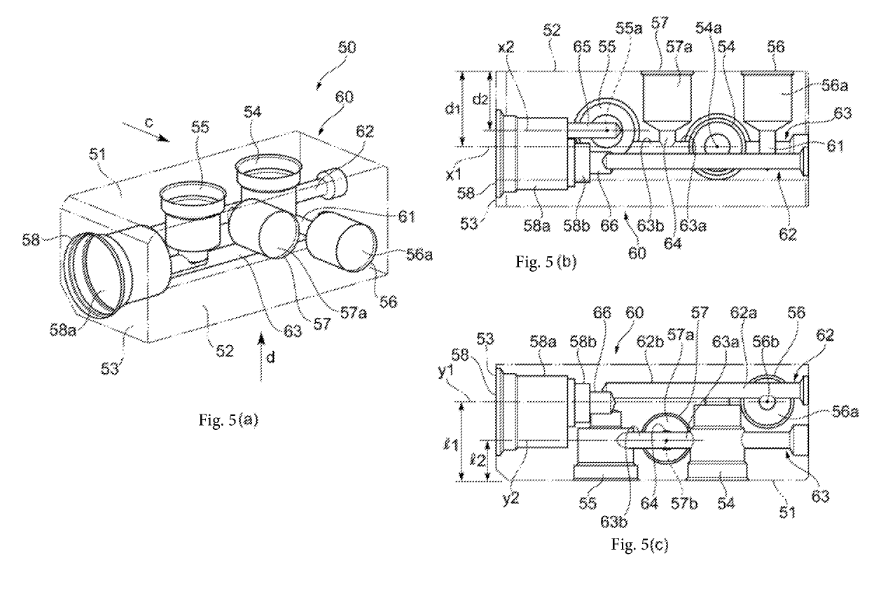

FIG. 5 is a transparent view illustrating another pipeline structure of the hydraulic pipeline inside the base body of the second embodiment of the present invention. FIG. 5(a) is a perspective view illustrating the pipeline structure, FIG. 5(b) is a diagram illustrating the pipeline structure when the base body is seen in the direction horizontal to the second side face (arrow c direction in FIG. 5(a)), and FIG. 5(c) is a diagram illustrating the pipeline structure when the base body is seen in the direction horizontal to the first side face (arrow d direction in FIG. 5(a)).

As illustrated in FIG. 5(a), similar to the base body 6 in the first embodiment, a base body 50 is a metallic member such as an aluminum alloy, including three side faces such as a first side face 51, a second side face 52, and a third side face 53. In the base body 50, the first side face 51, the second side face 52, and the third side face 53 are orthogonal and perpendicular to one another. In the present embodiment, as illustrated in FIG. 5(a), the base body 50 has a prismatic shape obtained by chamfering one long side of a rectangular parallelepiped. The base body 50 includes an inlet valve hole 54 accommodating the inlet valve 4, an outlet valve hole 55 accommodating the outlet valve 5, a master cylinder port 56 to be connected to the master cylinder 41, a wheel cylinder port 57 to be connected to the wheel cylinder 45, and a reservoir port 58 to be connected to the reservoir 17. The inlet valve hole 54 and the outlet valve hole 55 are open on the first side face 51. The master cylinder port 56 and the wheel cylinder port 57 are provided on the second side face 52. The reservoir port 58 is provided on the third side face 53. Inside the base body 50, a hydraulic pipeline 60 described below is formed. The inlet valve hole 54, the outlet valve hole 55, the master cylinder port 56, the wheel cylinder port 57, and the reservoir port 58 are formed by cutting the base body 50.

As illustrated in FIGS. 5(a) to 5(c), the inlet valve hole 54 and the outlet valve hole 55 are formed so as to open on the first side face 51 of the base body 50. The inlet valve hole 54 and the outlet valve hole 55 respectively have the same shape as the inlet valve hole 10 and the outlet valve hole 11 in the first embodiment.

As illustrated in FIG. 5(b), the inlet valve hole 54 is arranged so as to position its center 54a on an axis-x1 on the first side face 51 which is orthogonal to the third side face 53. As described in FIG. 5(b), the outlet valve hole 55 is arranged so as to position its center 55a on an axis-x2 on the first side face 51 which is parallel to the axis-x1. A gap d1 from the second side face 52 to the axis-x1 is greater than a gap d2 from the second side face 52 to the axis-x2 (d1>d2). In other words, an opening of the inlet valve hole 54 and an opening of the outlet valve hole 55 on the first side face 51 respectively have the gaps (d1 and d2) different from each other with respect to the second side face 52. The inlet valve hole 54 is formed at a position farther away from the second side face 52 than the outlet valve hole 55. In this manner, different from the inlet valve hole 10 and the outlet valve hole 11 in the first embodiment, the opening of the inlet valve hole 54 and the opening of the outlet valve hole 55 on the first side face 51 are arranged so as to be deviated in a direction perpendicular to the second side face 52.

As illustrated in FIGS. 5(a) to 5(c), in the base body 50, a port hole 56a and a port hole 57a extending respectively from the master cylinder port 56 and the wheel cylinder port 57 are formed on the second side face 52, in a direction perpendicular to the second side face 52. A pipeline connected to the master cylinder 41 is connected to the port hole 56a via the master cylinder port 56. The pipeline corresponds to a portion (the upstream side) of the pipeline 31 in the hydraulic circuit 30 of FIG. 3. A pipeline connected to the wheel cylinder 45 is connected to the port hole 57a via the wheel cylinder port 57. The pipeline corresponds to a portion (the downstream side) of the pipeline 35 in the hydraulic circuit 30 of FIG. 3. In accordance with a mounting position of the brake hydraulic pressure unit in a motorcycle, the master cylinder port 56 may be connected directly to the master cylinder 41, and the wheel cylinder port 57 may be connected directly to the wheel cylinder 45.

As illustrated in FIG. 5(c), the master cylinder port 56 is arranged so as to position its center 56b on an axis-y1 on the second side face 52 which is orthogonal to the third side face 53. As illustrated in FIG. 5(c), the wheel cylinder port 57 is arranged so as to position its center 57b on an axis-y2 on the second side face 52 which is parallel to the axis-y 1. A gap 11 from the first side face 51 to the axis-y1 is greater than a gap 12 from the first side face 51 to the axis-y2 (l1>l2). In other words, the master cylinder port 56 and the wheel cylinder port 57 respectively have the gaps (l1 and l2) different from each other with respect to the first side face 51. The master cylinder port 56 is formed at a position farther away from the first side face 51 than the wheel cylinder port 57. In this manner, different from the inlet valve hole 10 and the outlet valve hole 11 in the first embodiment, the master cylinder port 56 and the wheel cylinder port 57 on the second side face 52 are arranged so as to be deviated in a direction perpendicular to the first side face 51.

In the base body 50, the inlet valve hole 54, the outlet valve hole 55, the port hole 56a of the master cylinder port 56, and the port hole 57a of the wheel cylinder port 57 are formed at positions from the third side face 53 side in the order of the outlet valve hole 55, the port hole 57a of the wheel cylinder port 57, the inlet valve hole 54, and the port hole 56a of the master cylinder port 56 so as not to interfere with one another.

As illustrated in FIGS. 5(a) to 5(c), a port hole 58a extending from the reservoir port 58 formed on the third side face 53 in a direction perpendicular to the third side face 53 is formed in the base body 50. The reservoir 17 is connected to the port hole 58a via the reservoir port 58. Similarly to the first embodiment, the reservoir 17 may be formed by closing the port hole 58a, or the reservoir 17 may be embedded into the port hole 58a.

The hydraulic pipeline 60 includes pipelines 61 to 68. The pipeline 62 includes a pipeline portion 62a and a pipeline portion 62b. The pipeline 63 includes a pipeline portion 63a and a pipeline portion 63b. As illustrated in FIGS. 5(a) to 5(c), the pipeline 61 extends in a direction perpendicular to the second side face 52, and of which one end communicates with the port hole 56a connected to the master cylinder port 56.

The other end of the pipeline 61 communicates with the pipeline 62.

The pipeline 62 extends in a direction perpendicular to the third side face 53 and communicates with a bottom portion of the inlet valve hole 54, while communicating with the port hole 58a of the reservoir port 58 via the pipeline 66 as described below. A communication portion of the pipeline 62 and the inlet valve hole 54 is the entrance of the inlet valve 4. The third side face 53 side from a portion of the pipeline 62 connected to the inlet valve hole 54 is the pipeline portion 62b, and the opposite side is the pipeline portion 62a.

The pipeline 63 extends in a direction perpendicular to the third side face 53 and communicates with the inlet valve hole 54 and the outlet valve hole 55. The pipeline 63 communicates with the inlet valve hole 54 and the outlet valve hole 55 at a portion higher (on the opening sides of the inlet valve hole 54 and the outlet valve hole 55) than each of the bottom faces. A communication portion of the pipeline 63 and the inlet valve hole 54 is the exit of the inlet valve 4. A communication portion of the pipeline 63 and the outlet valve hole 55 is the entrance of the outlet valve 5.

The pipeline 64 extends in a direction perpendicular to the second side face 52. The pipeline 64 communicates with the pipeline 63 and a port hole 55a of the wheel cylinder port 55. The pipeline 64 is connected to the pipeline 63 between the inlet valve hole 54 and the outlet valve hole 55. In the pipeline 63, the inlet valve hole 54 side from a portion connected to the pipeline 64 is the pipeline portion 63a, and the outlet valve hole 55 side from a portion connected to the pipeline 64 is the pipeline portion 63b.

The pipeline 65 extends in a direction perpendicular to the third side face 53 and communicates with a bottom portion of the outlet valve hole 55 and the reservoir 17.

The pipeline 66 extends in a direction perpendicular to the third side face 53 from a bottom face of the port hole 58a of the reservoir port 58 and communicates with the port hole 58a of the reservoir port 58 and the pipeline 62. In more detail, similar to that in the first embodiment, a check valve accommodation chamber 58b for accommodating the check valve 34 is formed on the bottom face of the port hole 58a of the reservoir port 58. The pipeline 65 communicates with the check valve accommodation chamber 58b and the pipeline portion 62b of the pipeline 62.

As described above, the hydraulic pipeline 60 is configured to have the pipelines 61 to 66 and forms the hydraulic circuit 30 of FIG. 3. More specifically, the pipeline 61 and the pipeline portion 62a of the pipeline 62 respectively correspond to the circuit portion 31 of the hydraulic circuit 30 and the circuit portion 32. The pipeline portion 63a of the pipeline 63 and the pipeline 64 correspond to the circuit portion 35 of the hydraulic circuit 30. The pipeline portion 63b of the pipeline 63 corresponds to the circuit portion 36 of the hydraulic circuit 30. The pipeline 65, the pipeline 66, and the pipeline portion 62b of the pipeline 62 correspond to the circuit portion 33 of the hydraulic circuit 30.

When the pipeline is formed by cutting the base body 50, similarly to the first embodiment, the pipeline 62 and the pipeline 63 are open on a side face of the base body 50, as illustrated in FIG. 5. The opening portion is blocked by a plug (not illustrated). Each of the pipelines is positioned at a place other than the communicating place so as not to interfere with one another.

In the present embodiment, the base body 50 is shaped to be a prismatic body. The shape of the base body 50 is not limited thereto and the base body 50 may have a different shape. However, in the base body 50 regardless of its shape, the first side face, the second side face, and the third side face are perpendicular to one another.

Similarly to the first embodiment, the inlet valve hole 54 and the outlet valve hole 55 extend perpendicular to the first side face 51. However, the inlet valve hole 54 and the outlet valve hole 55 may extend having an angle not perpendicular to the first side face 51 within a range in which interference does not occur.

Similarly, the port hole 56a and the port hole 57a may extend having an angle not perpendicular to the second side face 52 within a range in which interference does not occur, and the port hole 58a may extend having an angle not perpendicular to the third side face 53 within a range in which interference does not occur.

Each of the pipelines is caused to be perpendicular to the corresponding side face. However, each of the pipelines may have an angle not perpendicular to the corresponding side face within a range in which interference does not occur.

As described above, according to the base body 50 in the second embodiment of the present invention, different from the base body 6 in the first embodiment of the present invention, the inlet valve hole 54 and the outlet valve hole 55 are arranged so as to be deviated from each other in a direction perpendicular to the second side face 52 (FIG. 5(b)). The inlet valve hole 54 is formed at a position farther away from the second side face 52 than the outlet valve hole 55. Therefore, the inlet valve hole 54 can directly communicate with the pipeline 62, and thus, the pipeline 23 of the base body 6 in the first embodiment can be omitted. Accordingly, the number of the pipeline portions of the hydraulic pipeline 60 can be reduced, and the pipeline portions of the hydraulic pipeline 60 can be arranged in a smaller space. Thus, it is possible to further miniaturize the base body 50. Moreover, it is possible to reduce the processing man-hours of the hydraulic pipeline 60.

According to the base body 50 in the second embodiment of the present invention, the inlet valve hole 54 and the outlet valve hole 55 are arranged so as to be deviated from each other as described above. Therefore, different from the base body 6 in the first embodiment of the present invention, the master cylinder port 56 and the wheel cylinder port 57 can be arranged so as to be deviated in a direction perpendicular to the first side face 51 (refer to FIG. 5(c)). Therefore, the port hole 57a of the wheel cylinder port 57 can directly communicate with the pipeline 63 via the pipeline 64, and thus, the pipeline 25 of the base body 6 in the first embodiment can be omitted. Accordingly, the number of the pipeline portions of the hydraulic pipeline 60 can be further reduced, and the pipeline portions of the pressure pipeline 60 can be arranged in a further smaller space. Thus, it is possible to further miniaturize the base body 50. Moreover, it is possible to further reduce the processing man-hours of the hydraulic pipeline 60.

In this manner, the base body 50 in the second embodiment of the present invention can be miniaturized to be smaller than the base body 6 in the first embodiment of the present invention. Thus, it is possible to further improve mounting characteristics of the brake hydraulic pressure unit in a motorcycle.

In the base body 50 of the second embodiment of the present invention, the master cylinder port 56 and the wheel cylinder port 57 are caused to be arranged so as to be deviated in a direction perpendicular to the first side face 51. However, similar to the base body 6 in the first embodiment, the master cylinder port 56 and the wheel cylinder port 57 may position their centers on the axis-y1. In this case, similar to the hydraulic pipeline 20 in the first embodiment, in order to connect the pipeline 63 and the pipeline 64 to each other, the pipeline (corresponding to the pipeline 25 in the first embodiment) extending in a direction perpendicular to the first side face 51 is formed in the hydraulic pipeline 60. In this case as well, as described above, the pipeline 23 in the first embodiment can be omitted. Thus, it is possible to further miniaturize the base body 50. Moreover, it is possible to reduce the processing man-hours of the hydraulic pipeline 60.

The brake hydraulic pressure unit according to the first and second embodiments of the present invention is not limited to a unit performing anti-lock braking control in the front wheel brake of a motorcycle and can be applied to various vehicles in which braking control is performed by a brake lever. For example, the brake hydraulic pressure unit may perform anti-lock braking control of a rear wheel brake in accordance with operations of a foot brake lever of a motorcycle.

Hereinbefore, the embodiments of the present invention have been described. However, the present invention is not limited to the embodiments of the present invention and includes every possible form included in the concept and Claims of the present invention. Each configuration may be appropriately and selectively combined so as to exhibit at least a portion of the above-described objects and effects.

### REFERENCE SIGNS LIST

1 BRAKE HYDRAULIC PRESSURE UNIT

2 HOUSING

3 VALVE CASE

4 INLET VALVE

5 OUTLET VALVE

6, 50 BASE BODY

7, 51 FIRST SIDE FACE

8, 52 SECOND SIDE FACE

9, 53 THIRD SIDE FACE

10, 54 INLET VALVE HOLE

10a, 11a, 12b, 13b, 54a, 56b, 57b CENTER

11, 55 OUTLET VALVE HOLE

12, 56 MASTER CYLINDER PORT

12a, 13a, 14a, 56a, 57a, 58a PORT HOLE

13, 57 WHEEL CYLINDER PORT

14, 58 RESERVOIR PORT

14b, 58b CHECK VALVE ACCOMMODATION CHAMBER

15 CONTROL SUBSTRATE

16 POWER SOURCE CONNECTOR

20, 60 HYDRAULIC PIPELINE

21 to 28, 61 to 68 PIPELINE

22a, 22b, 24a, 24b, 62a, 62b, 63a, 63b PIPELINE PORTION

30 HYDRAULIC CIRCUIT

41 MASTER CYLINDER

42 FRONT WHEEL

43 FRONT FORK

44 FRONT WHEEL BRAKE

45 WHEEL CYLINDER

46 BRAKE LEVER

31 to 36 CIRCUIT PORTION

x, x1, x2, y AXIS

d1, d2, l1, l2 GAP

1. A pumpless-type brake hydraulic pressure unit used in an anti-lock brake system, the unit comprising:
an inlet valve;
an outlet valve; and
a housing,
wherein the housing includes a base body, an inlet valve hole accommodating the inlet valve, an outlet valve hole accommodating the outlet valve, a master cylinder port connected to a master cylinder, a reservoir port connected to a reservoir, a wheel cylinder port connected to a wheel cylinder, and a pipeline,
wherein the base body includes a first side face, a second side face, and a third side face,
wherein the inlet valve hole and the outlet valve hole are open on the first side face, the master cylinder port and the wheel cylinder port are provided on the second side face, and the reservoir port is provided on the third side face, and
wherein the first side face and the second side face are perpendicular to one another, the first side face and the third side face are perpendicular to one another, and the second side face and the third side face are perpendicular to one another.

2. The brake hydraulic pressure unit according to claim 1,
wherein, on the first side face, a gap between an opening of the inlet valve hole and the second side face and a gap between an opening of the outlet valve hole and the second side face are the same.

3. The brake hydraulic pressure unit according to claim 1,
wherein, on the second side face, a gap between the master cylinder port and the first side face and a gap between the wheel cylinder port and the first side face are the same.

4. The brake hydraulic pressure unit according to claim 1, further comprising:
a valve case that accommodates the inlet valve and the outlet valve.

5. The brake hydraulic pressure unit according to claim 4, further comprising:
a control substrate that controls the inlet valve and the outlet valve,
wherein the control substrate is installed in the valve case.

6. The brake hydraulic pressure unit according to claim 1, further comprising:
a control substrate that controls the inlet valve and the outlet valve,
wherein the control substrate is installed away from the brake hydraulic pressure unit.

7. The brake hydraulic pressure unit according to claim 1,
wherein the base body is a rectangular parallelepiped.

8. The brake hydraulic pressure unit according to claim 1,
wherein the brake system is a one channel-type system.

9. The brake hydraulic pressure unit according to claim 1,
wherein the master cylinder is a body separated from the brake hydraulic pressure unit.

10. The brake hydraulic pressure unit according to claim 2,
wherein, on the second side face, a gap between the master cylinder port and the first side face and a gap between the wheel cylinder port and the first side face are the same.

11. The brake hydraulic pressure unit according to claim 10, further comprising:
a valve case that accommodates the inlet valve and the outlet valve.

12. The brake hydraulic pressure unit according to claim 11, further comprising:
a control substrate that controls the inlet valve and the outlet valve,
wherein the control substrate is installed in the valve case.

13. The brake hydraulic pressure unit according to claim 12, further comprising:
a control substrate that controls the inlet valve and the outlet valve,
wherein the control substrate is installed away from the brake hydraulic pressure unit.

14. The brake hydraulic pressure unit according to claim 13,
wherein the base body is a rectangular parallelepiped.

15. The brake hydraulic pressure unit according to claim 14,
wherein the brake system is a one channel-type system.

16. The brake hydraulic pressure unit according to claim 15,
wherein the master cylinder is a body separated from the brake hydraulic pressure unit.
